(19) United States
(12) Patent Application Publication
(10) Pub. No.: US 2013/0169446 A1
(43) Pub. Date: Jul. 4, 2013

(54) DEVICE FOR DISPLAYING ROTATION SPEED OF FAN

(71) Applicants: ZHENG-QUAN PENG, Shenzhen City (CN); ZHAO-YANG CAI, Shenzhen City (CN)

(72) Inventors: ZHENG-QUAN PENG, Shenzhen City (CN); ZHAO-YANG CAI, Shenzhen City (CN)

(21) Appl. No.: 13/668,384

(22) Filed: Nov. 5, 2012

(30) Foreign Application Priority Data
Dec. 28, 2011 (CN) 201110447348.1

(51) Int. Cl. G08B 21/00

(52) U.S. Cl. 340/670

(57) ABSTRACT

A device includes a main body and a control circuit received in the main body. The main body includes three push buttons and a display. The control circuit includes a parameter setting unit, a rotation speed detection unit, and a display unit. The push buttons are operated to input signals to the parameter setting unit. The parameter setting unit generates and saves a reference value according to the signals received from the push buttons, and outputs the reference value to the display unit. The rotation speed detection unit detects an actual rotation speed of a fan, and outputs the actual rotation speed to the display unit. The display unit controls the display to display the reference value and the actual rotation speed.

### BACKGROUND

1. Technical Field

The present disclosure relates to a device for displaying a rotation speed of a fan.

2. Description of Related Art

Fans as cooling tools are widely used in electronic devices, such as computers and servers. The electronic devices can measure rotation speeds of the fans. However, the electronic devices may not directly display the measured rotation speeds of the fans to the user. Therefore, there is room for improvement in the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the views.

FIG. 1 is a schematic diagram of a device for displaying a rotation speed of a fan in accordance with an embodiment of the present disclosure.

FIG. 2 is a block diagram of the device of FIG. 1 connected to a fan and a fan interface of a motherboard.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references can mean “at least one”.

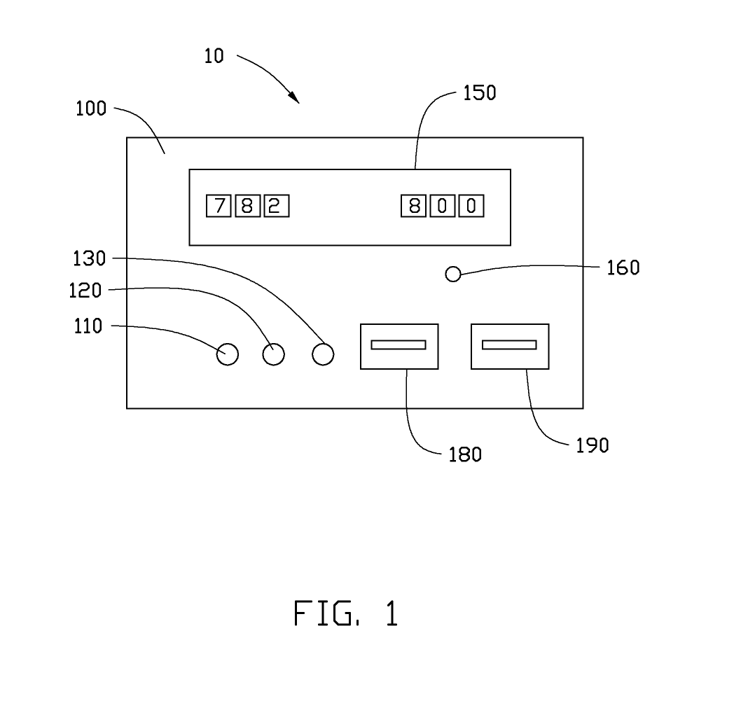

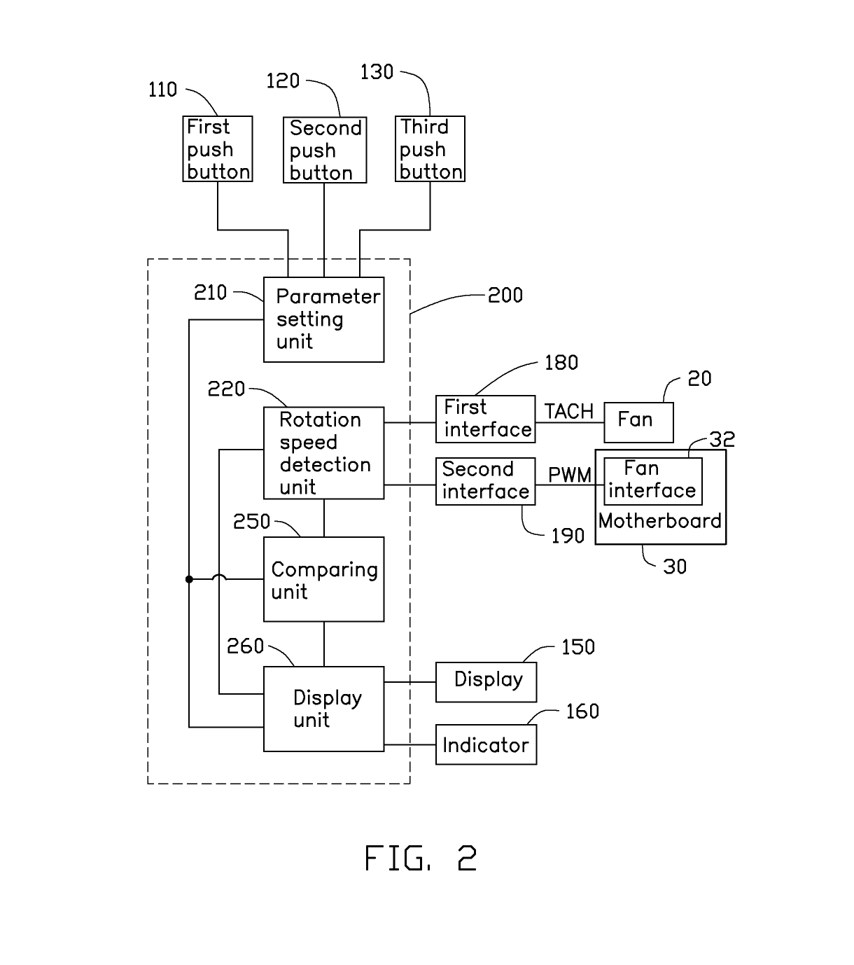

FIGS. 1 and 2 show an embodiment of a device 10. The device 10 is used to display a rotation speed of a fan 20. The device 10 includes a main body 100 and a control circuit 200 received in the main body 100. The main body 100 includes a first push button 110, a second push button 120, a third push button 130, a display 150, an indicator 160, a first interface 180, and a second interface 190. The control circuit 200 includes a parameter setting unit 210, a rotation speed detection unit 220, a comparing unit 250, and a display unit 260.

The parameter setting unit 210 is connected to the first push button 110, the second push button 120, the third push button 130, the comparing unit 250, and the display unit 260. The rotation speed detection unit 220 is connected to the comparing unit 250 and the display unit 260, connected to the fan 20 through the first interface 180, and connected to a fan interface 32 of a motherboard 30 through the second interface 190. The display unit 260 is connected to the display 150, the indicator 160, and the comparing unit 250.

The first push button 110, the second push button 120, and the third push button 130 are operated to input signals to the parameter setting unit 210. The parameter setting unit 210 is used to generate and save a reference value according to the signals received from the first push button 110, the second push button 120, and the third push button 130, and output the reference value to the comparing unit 250 and the display unit 260. The rotation speed detection unit 220 is used to transmit a pulse-width modulation signal PWM received from the fan interface 32 of the motherboard 30 to the fan 20, to control a rotation speed of the fan 20. The rotation speed detection unit 220 is further used to detect an actual rotation speed of the fan 20 according to the actual rotation speed signal TACH received from the fan 20, and output the actual rotation speed to the comparing unit 250 and the display unit 260. The comparing unit 250 is used to compare the actual rotation speed with the reference value, and output a control signal to the display unit 260, when the actual rotation speed is less than the reference value. The display unit 260 is used to store and automatically update the reference value received from the parameter setting unit 210. So that, the display unit 260 controls the display 150 to display previous reference value stored in the display unit 260 when the device 10 is turned on, automatically updates the stored reference value when receiving a reference value from the parameter setting unit 210, and controls the display 150 to display a current reference value. The display unit 260 is further used to control the display 150 to display the actual rotation speed received from the rotation speed detection unit 220, and control the indicator 160 to indicate that the actual rotation speed of the fan 20 is less than the reference value after receiving the control signal.

In use, the first interface 180 is connected to the fan 20, and the second interface 190 is connected to the fan interface 32 of the motherboard 30. The device 10 is turned on. The display 150 displays a previous reference value. When the previous reference value is a desired reference value, the third push button 130 is pressed. When the previous reference value is not the desired reference value, or no reference value is stored in the display unit 260, the desired reference value is needed to be set.

In one embodiment, the desired reference value may be set by using the following steps. The first push button 110 is operated to adjust a position of a cursor on the display 150 among different digits of a number, such as, units digit, tenths digit, and hundredths digit. For example, if hundredths digit is a desired place of the cursor, and the cursor is on the units digit actually, the first push button 110 is operated to adjust the cursor to the hundredths digit. The second push button 120 is operated to adjust value of a digit of the number which the cursor is located on, the value of the digit adds one when the second push button 120 is pressed once, and the value of the digit can be circularly adjusted among 0 to 9. For example, if a desired value of the hundredths digit is 7, and a current value of the hundredths digit is 1, the second push button 120 is pressed six times, to adjust a value of the hundredths digit to be 7. If the desired reference value, such as 782 shown in FIG. 1, is obtained by operating the first push button 110 and the second push button 120, the third push button 130 is operated to control the parameter setting unit 210 to save the desired reference value.

The parameter setting unit 210 transmits the reference value to the comparing unit 250 and the display unit 260. The rotation speed detection unit 220 detects an actual rotation speed of the fan 20, and transmits the actual rotation speed to the comparing unit 250 and the display unit 260. The comparing unit 250 compares the actual rotation speed with the reference value, and outputs a control signal to the display unit 260, when the actual rotation speed is less than the reference value. The display unit 260 controls the display 150 to display the reference value and the actual rotation speed, and controls the indicator 160 to indicate that the actual rotation speed of the fan 20 is less than the reference value after receiving the control signal. In one embodiment, the indicator 160 is a light-emitting diode (LED), the display unit 260 controls the LED to blink after receiving the control signal.

Even though numerous characteristics and advantages of the disclosure have been set forth in the foregoing description, together with details of the structure and function of the disclosure, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A device for displaying a rotation speed of a fan, the device comprising:
a main body comprising a first push button, a second push button, a third push button, a display, a first interface, and a second interface; and
a control circuit received in the main body, the control circuit comprising:
a parameter setting unit connected to the first push button, the second push button, and the third push button;
a rotation speed detection unit connected to the fan through the first interface, and connected to a fan interface of a motherboard though the second interface; and
a display unit connected to the display, the parameter setting unit, and the rotation speed detection unit;
wherein each of the push button, the second push button, and the third push button is operated to input signals to the parameter setting unit, the parameter setting unit generates and saves a reference value according to the signals received from the first push button, the second push button, and the third push button, and outputs the reference value to the display unit;
wherein the rotation speed detection unit transmits a pulse-width modulation signal received from the fan interface to the fan to control a rotation speed of the fan, detects an actual rotation speed of the fan and outputs the actual rotation speed to the display unit; and
wherein the display unit controls the display to display the reference value and the actual rotation speed.

2. The device of claim 1, wherein the first push button is operated to adjust a position of a cursor on the display among different digits of a number, the digits of the number includes units digit, tenths digit, and hundredths digit; the second push button is operated to adjust value of a digit of the number which the cursor is located on; and the third push button is operated to control the parameter setting unit to save the reference value.

3. The device of claim 1, wherein the display unit controls the display to display a previous reference value stored in the display unit in response to the device being turned on, automatically updates the stored reference value in response to receiving a reference value from the parameter setting unit, and controls the display to display a current reference value.

4. The device of claim 1, wherein the main body further comprises an indicator connected to the display unit, the control circuit further comprises a comparing unit connected to the parameter setting unit, the rotation speed detection unit, and the display unit; the comparing unit compares the reference value received from the parameter setting unit with the actual rotation speed received from the rotation speed detection unit, and outputs a control signal to the display unit in response to the actual rotation speed being less than the reference value; the display unit controls the indicator to indicate that the actual rotation speed is less than the reference value, in response to the display unit receiving the control signal.
